(19) United States
(12) Patent Application Publication
(10) Pub. No.: US 2026/0211928 A1
(43) Pub. Date: Jul. 23, 2026

(54) TECHNIQUES FOR HYBRID LONG-CONTEXT SUMMARIZATION

(71) Applicant: Ally Financial Inc., Detroit, MI (US)

(72) Inventors: Samarth Somani, Charlotte, NC (US); Samira Shaikh, Charlotte, NC (US)

(21) Appl. No.: 19/034,395

(22) Filed: Jan. 22, 2025

(51) Int. Cl. G06F 16/34; G06F 16/355; G06F 40/289

(52) U.S. Cl. CPC G06F 16/345; G06F 16/355; G06F 40/289

(57) ABSTRACT

Methods, systems, and devices are described to support summarization of text documents. A text document may be processed to generate a set of text chunks, where each text chunk is concatenated together with other text chunks that are associated with different respective topics of the text document. A set of first summaries may be generated by performing a first summarization of content associated with each respective topic. In some aspects, the first summarization may be performed via extractive summarization of the content of a respective topic. After the first summarization, a second set of summaries may be generated by summarizing the set of first summaries using one or more large language models (LLMs), such that each second summary includes a title and a respective summary of each respective first summary of the set of first summaries. A final summary may be generated by combining the set of second summaries.

### FIELD OF TECHNOLOGY

The present disclosure relates generally to data management, including techniques for techniques for hybrid long-context summarization.

### BACKGROUND

An organization may include multiple teams of engineers and developers that develop applications (e.g., computing applications and software related to financial institutions, user connectivity, user engagement, or the like) that support data storage and other implementations. A data management system (DMS) may be employed to manage data associated with such computing systems. The data may be generated, stored, or otherwise used by the one or more computing systems, examples of which may include servers, databases, virtual machines, cloud computing systems, file systems (e.g., network-attached storage (NAS) systems), or other data storage or processing systems. The DMS—either individually or utilized with other computing techniques such as large language modeling (LLM), artificial intelligence (AI), and machine learning, may support data management services and information processing for the one or more computing systems.

In addition, the DMS may support natural language processing (NLP) techniques in order to synthesize, process, and summarize large quantities of data (including large quantities of text) generated in digital formats. For example, a large amount of text may be generated in digital form including from news articles, products, service reviews and scientific publications, e-libraries, social media posts, websites, online tutorials, e-publications, among other examples. In some aspects, documents that include large quantities of text may be scattered and unprocessed, and computational analysis and other processing techniques may be needed to gain useful information from such lengthy texts.

### SUMMARY

The described techniques relate to improved methods, systems, devices, and apparatuses that support summarization of text documents. For example, a text document (e.g., a relatively long text document) may be processed to generate a set of text chunks. Each text chunk may be concatenated together with other text chunks that are associated with respective topics of the text document. A set of first summaries may be generated by performing a first summarization of content associated with each respective topic. In some aspects, the first summarization may be performed via extractive summarization of the content of a respective topic. After the first summarization, a second set of summaries may be generated by summarizing the set of first summaries using one or more large language models (LLMs), such that each second summary includes a title and a respective summary for each respective first summary of the set of first summaries. A final summary may be generated by combining the set of second summaries. Such techniques may implement the combination of topic modeling, extractive summarization, and generative AI for generating a summary of a relatively long document, which may result in accurate and representative summarization of the main topics of a document, where each topic may have a separate summary, thereby making the summary easy to follow and comprehend.

A method by an apparatus is described. The method may include processing a text document to generate a set of text chunks, where each text chunk of the set of text chunks has a length that is based on a total length of the text document, determining one or more topics associated with the set of text chunks, where each topic is associated with respective subsets of text chunks of the set of text chunks based on content similarities within the respective subsets of text chunks, concatenating the respective subsets of text chunks for each topic of the one or more topics, generating a set of first summaries of the one or more topics by performing a first summarization of content associated with each topic of the one or more topics, where the first summarization is performed by extracting, when a length of the content within the one or more topics satisfies a threshold length, a quantity of sentences from the one or more topics based on the threshold quantity of sentences satisfying a relevance metric, generating a set of second summaries by summarizing the set of first summaries using one or more large language models (LLMs), where each second summary of the set of second summaries includes a title and a respective summary for each respective first summary of the set of first summaries, and generating a final summary of the text document as a combination of the set of second summaries.

An apparatus is described. The apparatus may include one or more memories storing processor executable code, and one or more processors coupled with the one or more memories. The one or more processors may individually or collectively be operable to execute the code to cause the apparatus to process a text document to generate a set of text chunks, where each text chunk of the set of text chunks has a length that is based on a total length of the text document, determine one or more topics associated with the set of text chunks, where each topic is associated with respective subsets of text chunks of the set of text chunks based on content similarities within the respective subsets of text chunks, concatenate the respective subsets of text chunks for each topic of the one or more topics, generate a set of first summaries of the one or more topics by performing a first summarization of content associated with each topic of the one or more topics, where the first summarization is performed by extracting, when a length of the content within the one or more topics satisfies a threshold length, a quantity of sentences from the one or more topics based on the threshold quantity of sentences satisfying a relevance metric, generate a set of second summaries by summarizing the set of first summaries using one or more LLMs, where each second summary of the set of second summaries includes a title and a respective summary for each respective first summary of the set of first summaries, and generate a final summary of the text document as a combination of the set of second summaries.

Another apparatus is described. The apparatus may include means for processing a text document to generate a set of text chunks, where each text chunk of the set of text chunks has a length that is based on a total length of the text document, means for determining one or more topics associated with the set of text chunks, where each topic is associated with respective subsets of text chunks of the set of text chunks based on content similarities within the respective subsets of text chunks, means for concatenating the respective subsets of text chunks for each topic of the one or more topics, means for generating a set of first summaries of the one or more topics by performing a first summarization of content associated with each topic of the one or more topics, where the first summarization is performed by extracting, when a length of the content within the one or more topics satisfies a threshold length, a quantity of sentences from the one or more topics based on the threshold quantity of sentences satisfying a relevance metric, means for generating a set of second summaries by summarizing the set of first summaries using one or more LLMs, where each second summary of the set of second summaries includes a title and a respective summary for each respective first summary of the set of first summaries, and means for generating a final summary of the text document as a combination of the set of second summaries.

A non-transitory computer-readable medium storing code is described. The code may include instructions executable by one or more processors to process a text document to generate a set of text chunks, where each text chunk of the set of text chunks has a length that is based on a total length of the text document, determine one or more topics associated with the set of text chunks, where each topic is associated with respective subsets of text chunks of the set of text chunks based on content similarities within the respective subsets of text chunks, concatenate the respective subsets of text chunks for each topic of the one or more topics, generate a set of first summaries of the one or more topics by performing a first summarization of content associated with each topic of the one or more topics, where the first summarization is performed by extracting, when a length of the content within the one or more topics satisfies a threshold length, a quantity of sentences from the one or more topics based on the threshold quantity of sentences satisfying a relevance metric, generate a set of second summaries by summarizing the set of first summaries using one or more LLMs, where each second summary of the set of second summaries includes a title and a respective summary for each respective first summary of the set of first summaries, and generate a final summary of the text document as a combination of the set of second summaries.

In some examples of the method, apparatus, and non-transitory computer-readable medium described herein, processing the text document to generate the set of text chunks may include operations, features, means, or instructions for determining the total length of the text document and separating the text document into the set of text chunks, where each text chunk of the set of text chunks may have respective lengths that may be based on the total length of the text document.

In some examples of the method, apparatus, and non-transitory computer-readable medium described herein, processing the text document to generate the set of text chunks may include operations, features, means, or instructions for recursively splitting the total length of the text document at different locations in the text document marked by one or more identified characters, where the one or more identified characters include a paragraph end, a period, or both.

In some examples of the method, apparatus, and non-transitory computer-readable medium described herein, the set of text chunks may have respective lengths that may be each within a threshold magnitude of each other.

Some examples of the method, apparatus, and non-transitory computer-readable medium described herein may further include operations, features, means, or instructions for embedding each text chunk of the set of text chunks in accordance with an embedding model, where the embedding model may be based on a multi-dimensional dense vector space.

In some examples of the method, apparatus, and non-transitory computer-readable medium described herein, determining the one or more topics associated with the set of text chunks may include operations, features, means, or instructions for generating a chunk similarity matrix that may be indicative of the content similarities between respective pairs of text chunks of the set of text chunks.

In some examples of the method, apparatus, and non-transitory computer-readable medium described herein, determining the one or more topics associated with the set of text chunks may include operations, features, means, or instructions for grouping the respective subsets of text chunks using one or more community detection algorithms, where each subset of text chunks of the respective subsets of text chunks may be similar text chunks identified via the chunk similarity matrix.

Some examples of the method, apparatus, and non-transitory computer-readable medium described herein may further include operations, features, means, or instructions for generating a list based on concatenating the respective subsets of text chunks, where each item of the list may be indicative of a respective subset of text chunks assigned to a same topic.

Some examples of the method, apparatus, and non-transitory computer-readable medium described herein may further include operations, features, means, or instructions for determining that the length of content within the one or more topics includes a set of sentences that fails to satisfy the threshold length and generating the set of second summaries using the set of sentences from the one or more topics based on the length of content failing to satisfy the threshold length.

In some examples of the method, apparatus, and non-transitory computer-readable medium described herein, the threshold length of the content may be configured in accordance with one or more parameters.

Some examples of the method, apparatus, and non-transitory computer-readable medium described herein may further include operations, features, means, or instructions for generating a list based on generation of the set of first summaries, where each item of the list may be indicative of a respective first summary for a respective topic.

In some examples of the method, apparatus, and non-transitory computer-readable medium described herein, generating the set of second summaries may include operations, features, means, or instructions for entering, into the one or more LLMs, individual engineered prompts associated with respective individual single first summaries of the set of first summaries, generating respective individual second summaries of the set of second summaries in accordance with the individual engineered prompts, and generating a corresponding set of titles for each of the respective individual second summaries.

In some examples of the method, apparatus, and non-transitory computer-readable medium described herein, the combination of the set of second summaries including the final summary includes respective summaries for each topic of the one or more topics.

Some examples of the method, apparatus, and non-transitory computer-readable medium described herein may further include operations, features, means, or instructions for performing a post-processing of the final summary in accordance with a regular expression search.

In some examples of the method, apparatus, and non-transitory computer-readable medium described herein, the set of first summaries include one or more extractive summaries, and the set of second summaries include one or more abstractive summaries.

### BRIEF DESCRIPTION OF THE DRAWINGS

FIG. 1 illustrates an example of a computing environment that supports techniques for hybrid long-context summarization in accordance with aspects of the present disclosure.

FIG. 2 shows an example of a hybrid summarization model flow that supports techniques for hybrid long-context summarization in accordance with aspects of the present disclosure.

FIG. 3 shows an example of a hybrid summarization model that supports techniques for hybrid long-context summarization in accordance with aspects of the present disclosure.

FIG. 4 shows an example of a process flow that supports techniques for hybrid long-context summarization in accordance with aspects of the present disclosure.

FIG. 5 shows a block diagram of a system that supports techniques for hybrid long-context summarization in accordance with aspects of the present disclosure.

FIG. 6 shows a block diagram of a summarization component that supports techniques for hybrid long-context summarization in accordance with aspects of the present disclosure.

FIG. 7 shows a diagram of a system including a device that supports techniques for hybrid long-context summarization in accordance with aspects of the present disclosure.

FIG. 8 shows a flowchart illustrating methods that support techniques for hybrid long-context summarization in accordance with aspects of the present disclosure.

### DETAILED DESCRIPTION

Large language models (LLMs) may include machine learning models and other artificial intelligence (AI)-driven models designed for natural language processing tasks such as language and text generation (e.g., generative AI), among other generative tasks. One example of an LLM includes generative pretrained transformers (GPTs), which may be fine-tuned for specific tasks or guided by prompt engineering. An LLM may be assigned various tasks to execute, one of which being summarization of long texts such as books, academic works, podcast transcripts or other audio transcripts, and other text-based documents. In some implementations, an LLM may summarize long texts using recursive summarization, in which a long text is split equally into shorter chunks which can fit inside a context window of the LLM. Each chunk may then be summarized, and the summaries may be concatenated together and input into a GPT (or another AI tool) to be summarized further. The process of chunking text and summarization may be repeated until a final summary of desired length is obtained. In some aspects, however, some existing techniques split text into chunks without regard for logical and/or structural flow of the text. For example, equal chunking may lack regard for different topics or main ideas included in the text (e.g., a chunk may be split in the middle of an important topic, which may lead to inadequate or incomplete summarization of the topic).

Some other long context summarization methods may include inputting an entire document into an LLM to generate a summary, or summarization using a concatenation of multiple, relatively smaller summaries. In such cases, the final summary may be subject to various issues that affect the accuracy and viability of a generated summary. One possible issue may be referred to as a “positional bias issue,” were content that is originally included in the beginning of the document may be more likely to be represented in the final summary, while content that is included later in the document may be less likely to be represented in the final summary. Additionally, or alternatively, in some examples, a long form summarization may encounter a lack of a controlled compression ratio, where the length of the summary may stay relatively constant regardless of the document size, which may introduce challenges with longer documents, in which more detailed summaries are justified (and/or expected) in order to accurately capture the main ideas of the document. In some other examples, long context summarization methods may lack visibility for the user. For example, an LLM may be a “black box model,” and the user may be unable to determine how summaries are generated by the LLM and/or how critical or important information (e.g., information that allows a reader to accurately interpret the main ideas of the original document) is chosen for the final summary.

To support more efficient and accurate summarization of texts, hybrid free-from document summarization techniques may be implemented in order to generate a summary from an input of relatively lengthy texts. For example, an original document may be identified for summarization, and may undergo a summarization process that includes text chunking, topic modeling (e.g., community detection), extractive summarization, and abstractive summarization using generative AI, which together may be used to generate a final summary of the original document. During a first step, text chunking may be performed by first calculating chunk size (based on document size and using one or more formulas or algorithms), and after calculating the chunk size, the original document may be recursively split (e.g., using character markers) into similar size chunks (e.g., in accordance with the calculated chunk size) in order to keep similar ideas together. During a second step, the text chunks may be embedded and may undergo topic modeling, in which a chunk similarity matrix is used to group chunks into different distinct topics described by the original document. During a third step, extractive summarization may be performed on the distinct topics, and during a fourth step, abstractive summarization may be performed (using one or more LLMs or other generative AI models) to generate summaries of each topic. A final summary may then be generated as a concatenation of the abstractive summaries.

Aspects of the disclosure may be implemented to realize one or more potential advantages. For example, the combination of topic modeling, extractive summarization, and generative AI to generate a summary of a lengthy document may support more accurate and representative summarization of the main topics of a document, with each topic having a separate summary, making the summary easy to follow. In addition, the “positional bias” issue is remedied by summarization of each part of the document in an equal manner (e.g., without applying heavier weight to the beginning or end of the document, and reduced or eliminated positional bias). Additionally, or alternatively, the techniques described herein may allow for dynamically changing the chunk size (e.g., using a formula that may calculate and adjust the chunk size based on the length of the document) to optimize latency and performance, and allowing efficient scaling of summarization from smaller length documents to larger length documents. Additionally, or alternatively, the combination of topic modeling, extractive summarization, and generative AI may reduce token cost by reducing the quantity of input tokens. For example, the techniques described herein may not rely on the LLM to identify the important information of the summary, and eliminates the need for a large context window for the LLM, thereby eliminating the need for a complex or advanced LLM. The techniques described herein may also allow for increased visibility for summarization (e.g., by relying less on the LLM to generate important sentences, and improved abilities to select important information prior to LLM summary generation).

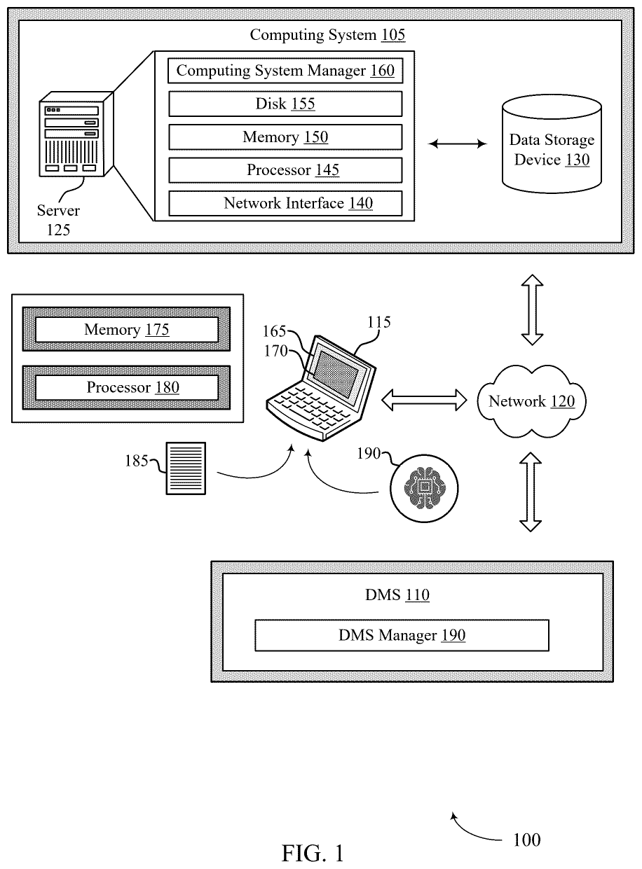

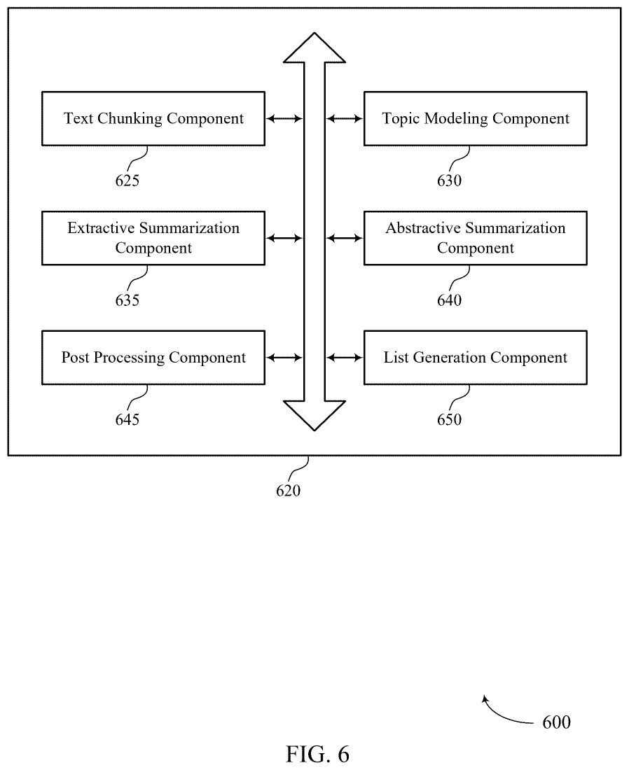

Aspects of the disclosure are initially described in the context of systems, summarization models, and process flows with reference to FIGS. 1 through 5. Aspects of the disclosure are further illustrated by and described with reference to systems and flowcharts that relate to techniques for verifying a sender identity using a user-generated identifier with reference to FIGS. 6 through 8.

This description provides examples, and is not intended to limit the scope, applicability or configuration of the principles described herein. Rather, the ensuing description will provide those skilled in the art with an enabling description for implementing various aspects of the principles described herein. As can be understood by one skilled in the art, various changes may be made in the function and arrangement of elements without departing from the application.

It should be appreciated by a person skilled in the art that one or more aspects of the disclosure may be implemented in a system to additionally, or alternatively, solve other problems than those described herein. Further, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

FIG. 1 illustrates an example of a computing environment 100 that supports techniques for hybrid long-context summarization in accordance with aspects of the present disclosure. The computing environment 100 may include a computing system 105, a data management system (DMS) 110, and one or more computing devices 115, which may be in communication with one another via a network 120. The computing system 105 may generate, store, process, modify, or otherwise use associated data, and the DMS 110 may provide one or more data management services for the computing system 105. For example, the DMS 110 may provide a data classification service, a data transfer or replication service, one or more other data management services, one or more data processing services, AI or machine learning implementation services, or any combination thereof for data associated with the computing system 105.

AI systems (such as AI system 190) that have been developed to mimic human-level intelligence have been widely deployed to support various processes such as task automation, decision-making optimizations, content generation, all while supporting innovation across fields like healthcare, technology, education, and finance. Such AI systems support ongoing learning, including ongoing adaptations and optimizations based on assigned tasks. AI technology may include various different sub-technologies such as machine learning (for example, deep learning) and elementary technology utilizing machine learning. Machine learning may include one or more algorithms that classify data and adaptively learns the features of input data. Elementary technology may include technologies that mimic cognitive functions, such as recognition and judgment of the human brain, using a machine learning algorithm such as deep learning, consisting of technical fields including linguistic understanding, visual understanding, inference and/or prediction modeling, knowledge presentation, operation control, among other aspects.

The functions of AI technology may be applied in various different formats and in various different fields and application scenarios. For example, linguistic understanding may be utilized in AI for recognizing, applying/processing human language/characters and includes natural language processing, machine translation, dialogue system, question and answer, speech recognition and synthesis, among other processes. Visual understanding may be utilized in AI for recognizing and processing objects as human vision, including object recognition, object tracking, image search, human recognition, scene understanding, spatial understanding, image enhancement, among other processes. Inference prediction may be utilized in AI as a technique for judging and logically inferring and predicting information, including knowledge and/or probability based inference, optimization prediction, preference-based planning, and recommendation. Knowledge representation may be implemented in AI as a technology for automating human experience information into knowledge data, including knowledge building (e.g., data generation and/or classification) and knowledge management (e.g., data utilization). Additionally, or alternatively, AI may support motion control techniques for controlling the autonomous running of the vehicle and the motion of the robot, including motion control (e.g., navigation, collision, driving), operation control (e.g., behavior control), among other techniques.

FIG. 1 may illustrate a computing environment 100 and related systems that may support one or more AI-based technologies, including generative AI and summarization techniques executed or performed using the AI system 190. The network 120 may allow the one or more computing devices 115, the computing system 105, and the DMS 110 to communicate (e.g., exchange information) with one another. The network 120 may include aspects of one or more wired networks (e.g., the Internet), one or more wireless networks (e.g., cellular networks), or any combination thereof. The network 120 may include aspects of one or more public networks or private networks, as well as secured or unsecured networks, or any combination thereof. The network 120 also may include any quantity of communications links and any quantity of hubs, bridges, routers, switches, ports or other physical or logical network components.

A computing device 115 may be used to input information to or receive information from the computing system 105, the DMS 110, or both. For example, a user of the computing device 115 may provide user inputs via the computing device 115, which may result in commands, data, or any combination thereof being communicated via the network 120 to the computing system 105, the DMS 110, or both. Additionally, or alternatively, a computing device 115 may output (e.g., display) data or other information received from the computing system 105, the DMS 110, or both. A user of a computing device 115 may, for example, use the computing device 115 to interact with one or more user interfaces (e.g., graphical user interfaces (GUIs)) to operate or otherwise interact with the computing system 105, the DMS 110, or both. Though one computing device 115 is shown in FIG. 1, it is to be understood that the computing environment 100 may include any quantity of computing devices 115.

A computing device 115 may be a stationary device (e.g., a desktop computer or access point) or a mobile device (e.g., a laptop computer, tablet computer, or cellular phone). In some examples, a computing device 115 may be a commercial computing device, such as a server or collection of servers. And in some examples, a computing device 115 may be a virtual device (e.g., a virtual machine). Though shown as a separate device in the example computing environment 100 of FIG. 1, it is to be understood that in some cases a computing device 115 may be included in (e.g., may be a component of) the computing system 105 or the DMS 110.

The computing system 105 may include one or more servers 125 and may provide (e.g., to the one or more computing devices 115) local or remote access to applications, databases, documents, or files stored within the computing system 105. The computing system 105 may further include one or more data storage devices 130. Though one server 125 and one data storage device 130 are shown in FIG. 1, it is to be understood that the computing system 105 may include any quantity of servers 125 and any quantity of data storage devices 130, which may be in communication with one another and collectively perform one or more functions ascribed herein to the server 125 and data storage device 130.

A data storage device 130 may include one or more hardware storage devices operable to store data, such as one or more hard disk drives (HDDs), magnetic tape drives, solid-state drives (SSDs), storage area network (SAN) storage devices, or network-attached storage (NAS) devices. In some cases, a data storage device 130 may comprise a tiered data storage infrastructure (or a portion of a tiered data storage infrastructure). A tiered data storage infrastructure may allow for the movement of data across different tiers of the data storage infrastructure between higher-cost, higher-performance storage devices (e.g., SSDs and HDDs) and relatively lower-cost, lower-performance storage devices (e.g., magnetic tape drives). In some examples, a data storage device 130 may be a database (e.g., a relational database), and a server 125 may host (e.g., provide a database management system for) the database.

A server 125 may allow a client (e.g., a computing device 115) to download information or files (e.g., executable, text, application, audio, image, or video files) from the computing system 105, to upload such information or files to the computing system 105, or to perform a search query related to particular information stored by the computing system 105. In some examples, a server 125 may act as an application server or a file server. In general, a server 125 may refer to one or more hardware devices that act as the host in a client-server relationship or a software process that shares a resource with or performs work for one or more clients.

A server 125 may include a network interface 140, processor 145, memory 150, disk 155, and computing system manager 160. The network interface 140 may enable the server 125 to connect to and exchange information via the network 120 (e.g., using one or more network protocols). The network interface 140 may include one or more wireless network interfaces, one or more wired network interfaces, or any combination thereof. The processor 145 may execute computer-readable instructions stored in the memory 150 in order to cause the server 125 to perform functions ascribed herein to the server 125. The processor 145 may include one or more processing units, such as one or more central processing units (CPUs), one or more graphics processing units (GPUs), or any combination thereof. The memory 150 may comprise one or more types of memory (e.g., random access memory (RAM), static random access memory (SRAM), dynamic random access memory (DRAM), read-only memory (ROM), electrically erasable programmable read-only memory (EEPROM), Flash, etc.). Disk 155 may include one or more HDDs, one or more SSDs, or any combination thereof. Memory 150 and disk 155 may comprise hardware storage devices. The computing system manager 160 may manage the computing system 105 or aspects thereof (e.g., based on instructions stored in the memory 150 and executed by the processor 145) to perform functions ascribed herein to the computing system 105. In some examples, the network interface 140, processor 145, memory 150, and disk 155 may be included in a hardware layer of a server 125, and the computing system manager 160 may be included in a software layer of the server 125. In some cases, the computing system manager 160 may be distributed across (e.g., implemented by) multiple servers 125 within the computing system 105.

In some examples, the DMS 110, and in particular a DMS manager, may be referred to as a control plane. The control plane may manage tasks, such as storing data management data, among other possible examples. In some examples, the control plane may be configured to manage the transfer of data management data to a cloud environment (e.g., Microsoft Azure or Amazon Web Services). In addition, or as an alternative, to being configured to manage the transfer of data management data to the cloud environment, the control plane may be configured to transfer metadata for the data management data to a cloud environment. The metadata may be configured to facilitate storage of the stored data management data, the management of the stored management data, the processing of the stored management data, the restoration of the stored data management data, and the like.

As illustrated in FIG. 1, the computing device 115 may include a display 165, a memory 175, a user interface 170, and a processor 180. Other components may additionally be included in the computing device 115. The display 165 may visually provide various screens. In particular, the display 165 may display a search screen including a document or search result containing a plurality of texts. In addition, the display 165 may also display summary information summarizing a document along with the document.

The memory 175 may store computer-readable instructions or data related to at least one other component of the computing device 115. In particular, the memory 175 may be implemented as a non-volatile memory, a volatile memory, a flash memory, a hard disk drive (HDD), or a solid state drive (SSD). The memory 175 is accessed by the processor 180 and read/write/modify/delete/update of data by the processor 180 can be performed. In the present disclosure, the memory may include the memory 175, ROM in the processor 180, RAM (not shown), or a memory card (for example, a micro SD card, and a memory stick) mounted to the computing device 115. In addition, the memory 175 may store computer-readable programs and data for configuring various screens to be displayed in the display area of the display 165.

In addition, the memory 175 may store one or more AI components (such as an AI agent) for generating summary information, and store the AI learning model (e.g., a document summarization model such as a long-form document summarization model) according to an embodiment. According to another embodiment, the AI learning model may be stored in another computing device or electronic component. The memory 175 may store various AI-based summarization components, including document chunking components, topic modeling components, extractive summarization components, one or more generative AI models, and one or more post-processing modules.

The user interface 170 may receive various user inputs and output signals corresponding thereto to the processor 180. In particular, the user interface 170 may include a touch sensor, a (digital) pen sensor, a pressure sensor, a mouse, a keyboard, or a key. The touch sensor can be, for example, at least one of an electrostatic type, a pressure sensitive type, an infrared type, and an ultrasonic type. The (digital) pen sensor may be, for example, a part of a touch panel or may include a separate recognition sheet. The key may include, for example, a physical button, an optical key, or a keypad. In particular, the user interface 170 may obtain an input signal according to a user input to select a document 185 to generate summary information or a user input to select a document 185 after pressing a specific button (for example, a button to execute an AI service). The user interface 170 may transmit a signal corresponding to the user input to the processor 180.

The processor 180 may be electrically connected to the display 165, the memory 175 and the user interface 170, for example via one or more buses, to control the overall operation and functions of the computing device 115. In particular, the processor 180 may perform operations to generate summary information for document 185 using various modules (including AI modules) and data stored in the memory 175, and the like. For example, a user select a document 185 as an input, and the processor 180 may input a selected document to the AI learning model to acquire summary information of the document 185 and control the display 165 to provide the summary information.

Various techniques for summarizing documents and providing summary information (for example, summary text) may be used. In particular, electronic apparatuses or programs may provide summarized information by summarizing documents using summary models obtained through AI learning. Therefore, there is a need to provide a user with various user experiences through a summarization function to summarize a document (including long-form documents) using a summarization model.

To support more efficient and accurate summarization of texts, hybrid free-from document summarization techniques may be implemented in order to generate a summary from an input of relatively lengthy texts (e.g., such as document 185). For example, the document 185 may be identified for summarization, and may undergo a summarization process that includes text chunking, topic modeling (e.g., community detection), extractive summarization, and abstractive summarization using generative AI, which together may be used to generate a final summary of the original document. During a first step of text chunking, a formula may be used to calculate an “ideal” (e.g., optimized, relatively equal) chunk size based on the original document, and the original document may be recursively split (e.g., using character markers) into similar size chunks in order to keep similar ideas together. During a second step, the text chunks may be embedded and may undergo topic modeling, in which a chunk similarity matrix is used to group chunks into different distinct topics described by the original document. During a third step, extractive summarization may be performed on the distinct topics, and during a fourth step, abstractive summarization may be performed (using one or more LLMs or other generative AI models) to generate summaries of each topic. A final summary may then be generated as a concatenation of the abstractive summaries.

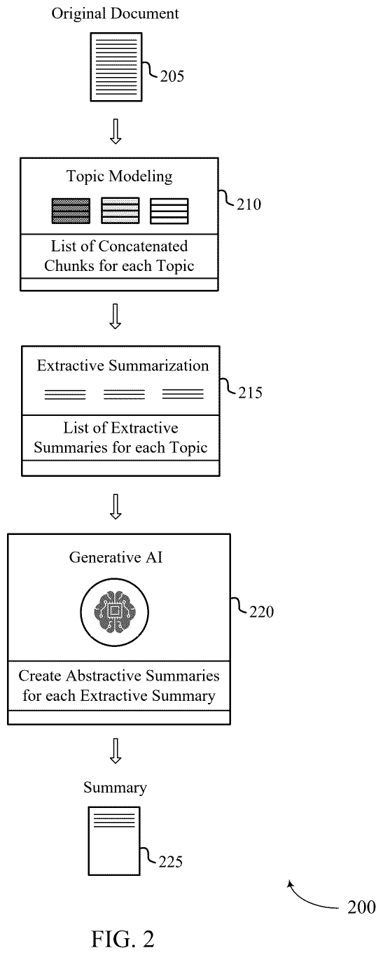

FIG. 2 shows an example of a hybrid summarization model flow 200 that supports techniques for hybrid long-context summarization in accordance with aspects of the present disclosure. For example, the hybrid summarization model flow may illustrate a process for efficiently and accurately summarizing text.

LLMs may include machine learning models designed for natural language processing tasks such as language and text generation (e.g., generative AI), among other generative tasks. LLMs may include many parameters, and may be trained with self-supervised learning on relatively large amounts of text. One example of an LLM includes generative pretrained transformers (GPTs), which may be fine-tuned for specific tasks or guided by prompt engineering. An LLM may be assigned various tasks to execute, one of which being summarization of long texts such as books, academic works, podcast transcripts or other audio transcripts, among other lengthy texts. In some implementations, an LLM may summarize long texts using recursive summarization, in which a long text is split equally (or approximately equally) into shorter chunks which can fit inside a context window of the LLM. Each chunk may then be summarized, and the summaries may be concatenated together and input into a GPT (or another AI tool) to be summarized further. The process of chunking text and summarization may be repeated until a final summary of desired length is obtained. In some aspects, however, some existing techniques split text into chunks without regard for logical and structural flow of the text. For example, equal chunking may lack regard for different topics or main ideas included in the text (e.g., a chunk may be split in the middle of an important topic, which may lead to lack of adequate summarization of the topic).

Another example of a text summarization method may include a “refine” method, which passes every chunk of text, along with a summary from previous chunks, through the LLM, which progressively refines the summary. Some such summary refinement methods lack the ability to be parallelized, which introduces significant latency relative to a recursive method. Additionally, or alternatively, refinement methods may over-represent initial and final parts of the document in the final summary, while underrepresenting other portions of the text.

Some other long context summarization methods may include inputting an entire document into an LLM to generate a summary. In such cases, the final summary may be subject to various issues that affect the accuracy and viability of a generated summary. One possible issue may be referred to as a “positional bias issue,” were content that is originally included in the beginning of the document may be more likely to be represented in the final summary, while content that is included later in the document may be less likely to be represented in the final summary. That is, content that is originally included in the beginning of the document may be more likely to be represented in the final summary, while content that is included later in the document may be less likely to be represented in the final summary. In some other examples, long context summarization may prioritize (and show positional bias) towards information in the beginning and end of the document, but may disregard (or at least underrepresent) relatively important information in the middle of the document. Additionally, or alternatively, in some examples, a long form summarization may encounter a lack of controlled compression ratio. For example, when prompting for long-context summarization, the model may be inconsistent with following instructions regarding document size. That is, the length of the summary may stay relatively constant regardless of the document size, which may introduce challenges with longer documents, in which more detailed summaries are justified in order to accurately capture the main ideas of the document. Additionally, or alternatively, the long context summarization may lead to summaries that lack specificity (e.g., the summarization may exclude specific numerical information or other specific information important to the main concepts of the document). In some other examples, the long context summarization methods may lack visibility for the user. For example, an LLM may be a “black box model,” and the user may be unable to determine how summaries are generated by the LLM, and how critical or important information is chosen for the final summary. In some other examples, the long context summarization may lack model flexibility. For example, a relatively large model with a relatively large context window may be selected in order to summarize a long document, with smaller models being excluded (due to smaller context windows that may not fit the large quantity of text being summarized.

Some other techniques of summarization may face similar issues as long context summarization. For example, techniques which generate a summary as a “summary of summaries” (e.g., a concatenation of smaller summaries to generate a final overall summary) may also be associated with the “positional bias” issue, where topics at the beginning and end of the larger text may be over-represented in the final summary because an LLM is still being used to generate the final summary of the larger text. Additionally, or alternatively, the “summary of summaries” summarization techniques may also suffer from a lack of controlled compression ratio, where a user may be unable to control the compression ratio and the length of the summary, making more detailed summaries of longer texts challenging to generate. In some other aspects, the summary of summaries method of summarization may be ineffective in maintaining context of the information being summarized. For example, the process of chunking information may be performed in such a way that one or more important ideas of a document may be located across different chunks (e.g., an important idea may be separated at the end of one chunk and the beginning of another), which may cause the summarization model to lose context and misinterpret the important information. Additionally, or alternatively, the summary of summaries summarization techniques may be computationally expensive (e.g., due to calling LLMs a large amount of times, leading to large input token cost), may lack specificity (e.g., specific details included in the summary may be lost across different summarized portions of the text), and there may be a lack of visibility when using LLMs for summarization (e.g., the LLMs may be effective “black boxes,” and it may be unclear as to how the LLMs are generating summaries).

To support more efficient and accurate summarization of texts, hybrid free-from document summarization techniques may be implemented in order to generate a summary from an input of relatively lengthy text (e.g., portable document formats (PDFs), Word documents and other word processing documents, digital text formats, among other related text formats). For example, an original document 205 may be identified for summarization, and may undergo a summarization process that includes topic modeling 210 (e.g., community detection), extractive summarization 215, and abstractive summarization 220 using generative AI, which together may be used to generate a final summary 225 of the original document 205.

For topic modeling 210, the summarization process may perform community detection to create subdocuments off of a single document, where each subdocument may represent a different topic of the document. After the different subdocuments each indicating different topic are generated, the summarization process may utilize extractive summarization 215 to generate an extractive summary of each subdocument for each topic. After extractive summaries are generated, the summarization process may use generative AI to perform abstractive summarization 220 to generate an abstractive summary and a title from each extractive summary. The final output of the summarization process includes the final summary 225, which may be a summary of the entire document, with titles and paragraphs that each represent a different topic of the original document 205.

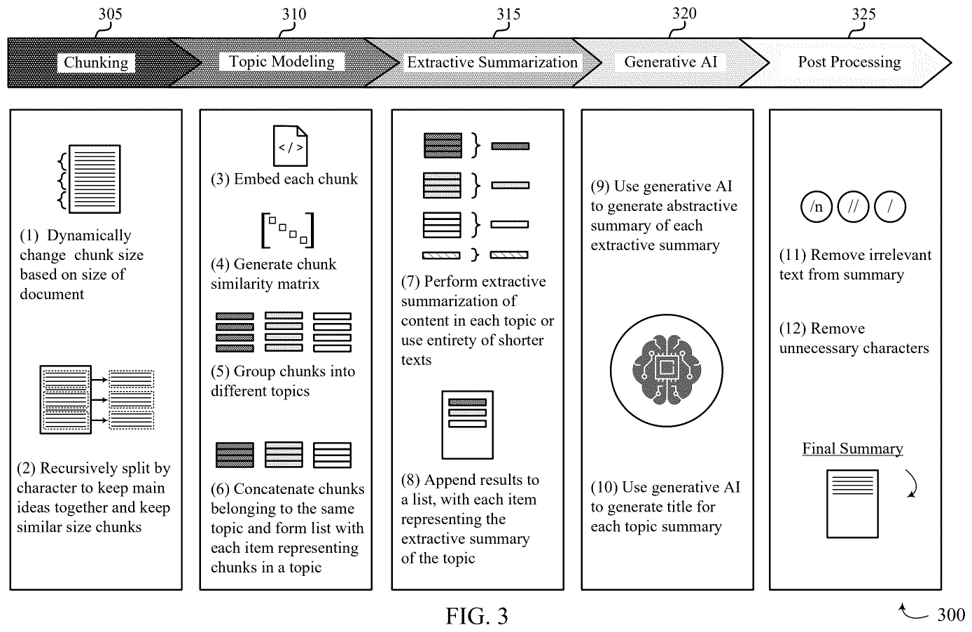

FIG. 3 shows an example of a hybrid summarization model 300 that supports techniques for hybrid long-context summarization in accordance with aspects of the present disclosure. For example, the hybrid summarization model 300 may support techniques for efficiently and accurately summarizing text.

The hybrid summarization model 300 may support efficient and accurate summarization of long text documents, where the final generated summary captures each of the most important topics of the document in context. The hybrid summarization model 300 may include various steps, including a chunking step 305, a topic modeling step 310, an extractive summarization step 315, a generative AI step 320 (e.g., abstractive summarization) and a post-processing step 325, where each step may include one or more sub-steps.

During the chunking step 305, the initial document may be “chunked” (e.g., separated, divided, split up) into a set of subdocuments (e.g., a quantity of sentences, lines of text, or characters of the initial document). At a first step, the chunk size may be dynamically changed (e.g., the chunk size may be dynamically changed using one or more calculations and/or formulas implemented on the back-end) based on the size of the initial document (e.g., based on the total quantity of sentences in the document). For example, the larger the quantity of sentences, the larger the chunk size. In such cases, the chunk size may be determined based on an optimization between processing latency and summary accuracy and performance for different document sizes. At a second step of the chunking step 305, the chunking may be performed by recursively splitting by character using an LLM integration framework (such as Langchain). Such recursive splitting may allow for the chunking to keep ideas together within respective chunks while maintaining similar size chunks over the total quantity of chunks. In some examples, the chunks may be of equal size, or approximately equal size (e.g., within a threshold difference between chunk sizes). In some examples, the chunking step 305 may generate a list of document chunks generated or identified.

During the topic modeling step 310, each chunk may be embedded using a sentence-transformers model (e.g., multi-qa-MiniLM-L6-cos-v1 or another sentence-transformers model). In some aspects, the sentence transformers model may map sentences and paragraphs to a dimensional dense vector space (e.g., a 384 dimensional dense vector space) designed for semantic search and/or clustering. A chunk similarity matrix may then be generated using the embedded chunks, where the chunk similarity matrix describes how semantically similar each chunk is to each other chunk (e.g., based on one or more similarity metrics). Chunks belonging to different topics may then be grouped using one or more algorithms (e.g., a Louvain Community Algorithm or other community detection processes). In some aspects, the number of topics may be equal to the number of chunks divided by 4.5. In some aspects, the number of topics may be determined or configured by a user, or calculated to be equal to the number of chunks divided by some other number different from 4.5. The chunks that belong to the same topic may then be concatenated together, and a list may be formed with each item in the list representing the chunks assigned to a specific topic.

During the extractive summarization step 315, extractive summarization may be performed on content in each topic using one or more methods, or the full content may be used without extractive summarization (e.g., for topics having content less than or equal to 30 sentences). For example, one possible extractive summarization technique may include a TextRank algorithm, which constructs a graph representing each word or phrase within the topic as a node, and the connections between these nodes (e.g., edges) may reflect the relationships and similarities between the words within the topic. Each node may then be assigned a score based on the scores of its connected words so that words with connections to high-scoring nodes (e.g., frequently occurring or semantically important words) are indicated as important to the final summary. That is, within each topic, the TextRank algorithm may identify the most important keywords within each topic, which may encapsulate core themes and concepts within each topic during extractive summarization. In some examples, if the topic content exceeds a threshold quantity of sentences (e.g., greater than 30 sentences or another selected quantity of sentences), extractive summarization may be performed in order to extract the most relevant information in the topic. Conversely, if the topic content is less than the threshold quantity of sentences (e.g., less than 30 sentences or less than another selected quantity of sentences), then extractive summarization may not be performed on the topic. After extractive summarization is performed, the results of the extractive summarization for each topic may be appended to a list, with each item in the list representing the extractive summary of the topic. Alternatively, if extractive summarization is not performed for a topic (e.g., the topic content has 30 sentences or less), the entire text associated with the topic may be passed through and appended to the list.

During the generative AI step 320, a GPT may be used to generate abstractive summaries of each extractive summary generated during the extractive summarization step 315. In some examples, an engineered prompt may be fed into an AI model or GPT using an LLM integration framework (such as Langchain) to generate abstractive summaries corresponding to each extractive summary. In some examples, the engineered prompt may include instructions to tell the AI model what to do, how to use external information (if provided), what to do with the query, and how to construct the output. Additionally, or alternatively, the engineered prompt may include external information and/or contextual information which may provide additional information for the AI model to use. Additionally, or alternatively, the engineered prompt may include a user input or query, and an output indicator marking the beginning of the to-be-generated text. In some examples, the abstractive summaries (representing corresponding extractive summaries) generated during the generative AI step 320 may represent a paragraph or other chunk of text in the final summary. In addition, the generative AI step 320 may generate a title for each topic summary, such that the final summary may include a title and a paragraph for each topic of the document. In some examples, the content for the title and the paragraph may be included in a list including pre-processed content.

During the post-processing step 325, the generated summary may be processed to a final summary by removing irrelevant text (e.g., characters that are a product of the generative AI step 320, such as “/,” “/n,” “//,” the token count, or any combination thereof). In some implementations, the summary may be processed using a regular expression (regex) search process (or another type of search process) that includes a sequence of characters specifying a match pattern in the generated text. In some aspects, the regular expression search process may be implemented as part of a string-search algorithm for “find” or “find and replace” operations on strings, or for input validation. Additionally, or alternatively, the post-processing step 325 may remove one or more sets of unnecessary characters (e.g., {“data”: [{“message”:{“role”; “assistant,” “content”: ) which may be present at the beginning of the title and paragraph, and the token count at the end of every title and paragraph, using the regular expression search process.

The output of the post-processing step 325 may be the final summary with a title and summary corresponding to each topic in the original document.

The hybrid summarization model 300 may support a combination of topic modeling, extractive summarization, and generative AI (e.g., abstractive summarization and title creation) which may have additional benefits relative to other summarization procedures (such as summarization procedures that include one or two of topic modeling, extractive summarization, and generative AI, but not a combination of all three). For example, some summarization models that include topic modeling and abstractive summarization may be costly and computationally intensive due to utilization of the LLM many times, and also relies on the LLM to summarize large pieces of texts, which may be inefficient relative to summarizing smaller extractive summaries. In addition, the combination of topic modeling and abstractive summarization may over-rely on the LLM to choose the important information, which may introduce “black box” issues (e.g., it may be unclear how the LLM is choosing the important information). Additionally, or alternatively, having longer text fed into the LLM may result in context window issues, positional bias issues, or both. In some other examples that include extractive and abstractive summarization, the summarization model may lack a desirable compression ratio, and may be overly reliant on extractive summarization. In some other examples that include topic modeling and extractive summarization, the output of summarization model may be incoherent or overly complex, may lack conciseness, may be unorganized, may be difficult to read, or any combination thereof. Additionally, or alternatively, the combination of topic modeling and extractive summarization may lack an ability to adjust for tone and style of the summary, and/or may lack an ability to customize the summary in one or more ways, that may be supported by prompt engineering and generative AI.

The combination of topic modeling, extractive summarization, and generative AI to generate a summary of a lengthy document may support more accurate and representative summarization of the main topics of a document, with each topic having a separate summary, making the summary easy to follow. In addition, the “positional bias” issue is remedied by summarization of each part of the document in an equal manner (e.g., without applying heavier weight to the beginning or end of the document, and reduced or eliminated positional bias). Additionally, or alternatively, the techniques described herein may allow the chunk size to dynamically change (e.g., the chunk size may be adjusted using a formula that depends at least partially on document length) to optimize latency and performance, and allowing efficient scaling of summarization from smaller length documents to larger length documents. Similarly, the combination of topic modeling, extractive summarization, and generative AI may allow for improved customizability and flexibility when choosing summary length, and how much detail should be included for each use case (e.g., no limitation of compression ratio for the summary, and no token limit, allowing for summarization of documents of any length). Additionally, or alternatively, the combination of topic modeling, extractive summarization, and generative AI may reduce token cost by reducing the quantity of input tokens. For example, the techniques described herein may not rely on the LLM to identify the important information of the summary, and eliminates the need for a large context window for the LLM, thereby eliminating the need for a complex or advanced LLM (e.g., the hybrid summarization model 300 may be supported by a relatively small or cheap LLM). The techniques described herein may also allow for increased visibility for summarization (e.g., by relying less on the LLM to generate important sentences, and improved abilities to select important information prior to LLM summary generation).

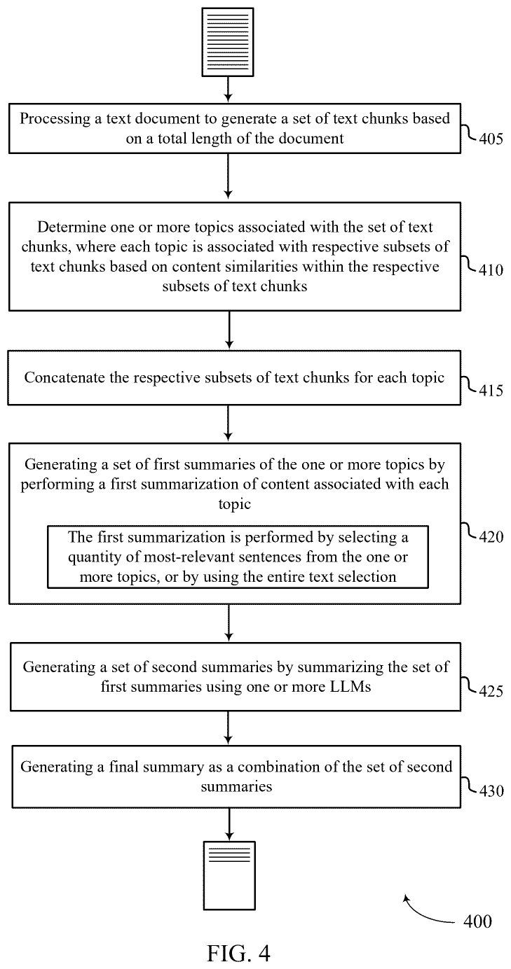

FIG. 4 shows an example of a process flow 400 that supports techniques for hybrid long-context summarization in accordance with aspects of the present disclosure. Alternative examples of the following may be implemented. Some steps are performed in a different order than described herein, may be performed simultaneously (e.g., in parallel), or are not performed at all. In some implementations, steps may include additional features not mentioned below, or additional steps may be added. Further, the operations of the process flow 400, may be performed by one or more software functions, computing nodes, computing systems, or other aspects capable of supporting the techniques described herein.

At 405, a text document may be processed to generate a set of text chunks, where each text chunk may have a length that is based on a total length of the document. In some examples, generating the set of text chunks may include determining the total length of the text document, and separating the text document into the set of text chunks, where each text chunk of the set of text chunks may have respective lengths that are based on the total length of the text document. In some examples, generating the set of text chunks may include recursively splitting the total length of the text document at different locations in the text document marked by one or more identified characters (e.g., marked by a paragraph end, a period, or both). In some examples, the set of text chunks may have respective lengths that are each within a threshold magnitude of each other (e.g., the set of text chunks may each have approximately the same size). In some examples, each text chunk may be embedded in accordance with an embedding model, where the embedding model may be based on a multi-dimensional dense vector space.

At 410, one or more topics may be determined to be associated with the set of text chunks, where each topic is associated with respective subsets of text chunks based on content similarities within the respective subsets of text chunks. In some examples, the one or more topics may be determined by generating a chunk similarity matrix that is indicative of the content similarities between respective pairs of text chunks of the set of text chunks. In some examples, the one or more topics may be determined by grouping respective subsets of text chunks using one or more community detection algorithms, wherein each subset of text chunks of the respective subsets of text chunks are similar text chunks identified via the chunk similarity matrix.

At 415, the respective subsets of text chunks for each topic may be concatenated. In some examples, a list may be generated to include the concatenated text chunks, where each item of the list is indicative of a respective subset of text chunks assigned to the same topic.

At 420, a set of respective individual first summaries (e.g., extractive summaries) may be generated of the one or more topics by performing a first summarization of content associated with each topic of the one or more topics, or by using the entire amount of content (e.g., if the number of sentences of a topic is less than or equal to 30 sentences, the entire content may be used without summarizing). In some examples, the first summarization may be performed by extracting, when a length of the content within the one or more topics satisfies a threshold length, a quantity of sentences from the one or more topics based at least in part on the threshold quantity of sentences satisfying a relevance metric. In some examples, the first set of summaries may be represented by a list, where each item of the list may be indicative of a respective summary for a topic. In some aspects, the threshold quantity of sentences used to create the first set of summaries may be configured in accordance with one or more parameters (e.g., the threshold sentence length may be a set value of sentences, or may be calculated or determined by an equation or ratio, or may be set by a user).

At 425, a set of second summaries (e.g., abstractive summaries) may be generated by summarizing the set of first summaries using one or more LLMs, where each second summary of the set of second summaries includes a title and a respective summary for each respective first summary of the set of first summaries. In some cases, a second summary may be generated using content within a topic (e.g., the extractive summary). In some aspects, the second summary may be an abstractive summary that is a summary of the entire length of content within the topic.

In some implementations, the second set of summaries may be generated by entering individual engineered prompts associated with respective individual single first summaries into one or more LLMs, generating respective individual second summaries using the engineered prompts, and generating a corresponding set of titles for each respective individual summary of the set of second summaries. In such implementations, the final summary may include respective summaries for each topic and the set of titles corresponding to each topic.

At 430, the final summary of the text document may be generated as a combination of the set of second summaries. In some examples, the final summary may be post-processed using a regular expression (regex) search to remove extraneous characters.

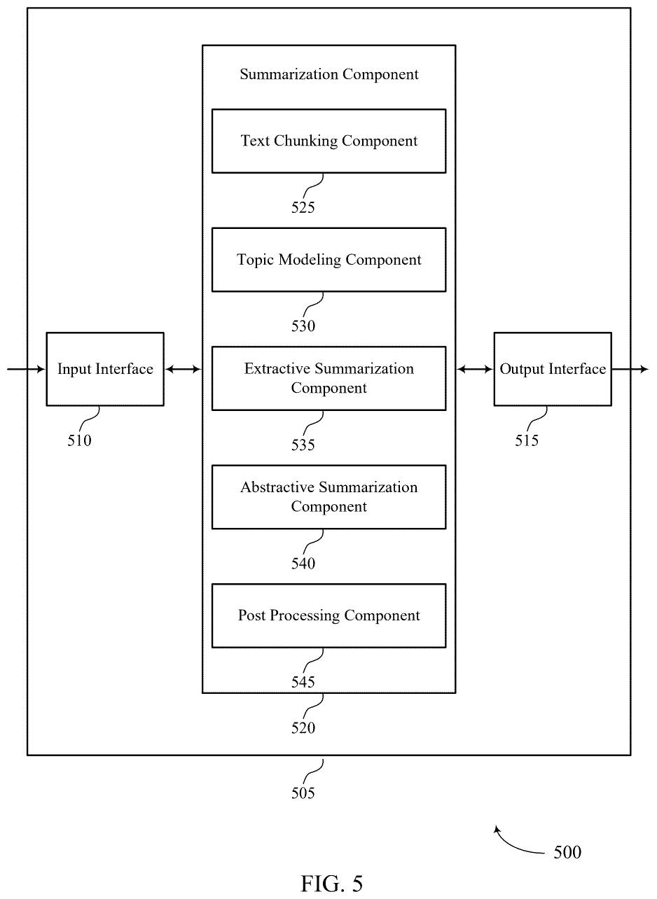

FIG. 5 shows a block diagram 500 of a system 505 that supports techniques for hybrid long-context summarization in accordance with aspects of the present disclosure. In some examples, the system 505 may be an example of aspects of one or more components described with reference to FIG. 1, such as a DMS 110. The system 505 may include an input interface 510, an output interface 515, and a summarization component 520. The system 505 may also include one or more processors. Each of these components may be in communication with one another (e.g., via one or more buses, communications links, communications interfaces, or any combination thereof).

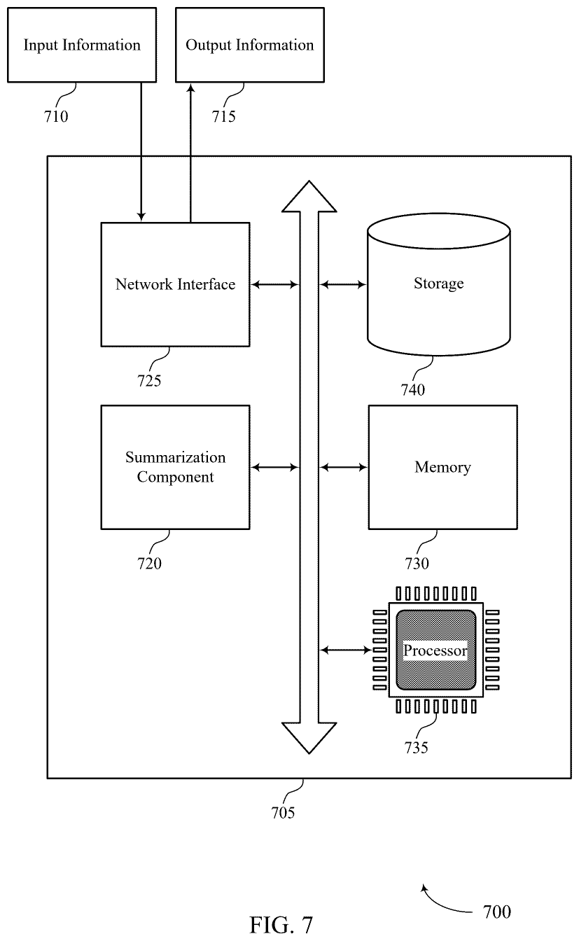

The input interface 510 may manage input signaling for the system 505. For example, the input interface 510 may receive input (e.g., messages, packets, data, instructions, commands, or any other form of encoded information) from other systems or devices. The input interface 510 may send signaling corresponding to (e.g., representative of or otherwise based on) such input signaling to other components of the system 505 for processing. For example, the input interface 510 may transmit such corresponding signaling to the summarization component 520 to support techniques for hybrid long-context summarization. In some cases, the input interface 510 may be a component of a network interface 725 as described with reference to FIG. 7.

The output interface 515 may manage output signaling for the system 505. For example, the output interface 515 may receive signaling from other components of the system 505, such as the summarization component 520, and may transmit such output signaling corresponding to (e.g., representative of or otherwise based on) such signaling to other systems or devices. In some cases, the output interface 515 may be a component of a network interface 725 as described with reference to FIG. 7.

For example, the summarization component 520 may include a text chunking component 525, a topic modeling component 530, an extractive summarization component 535, an abstractive summarization component 540, a post processing component 545, or any combination thereof. In some examples, the summarization component 520, or various components thereof, may be configured to perform various operations (e.g., receiving, monitoring, transmitting) using or otherwise in cooperation with the input interface 510, the output interface 515, or both. For example, the summarization component 520 may receive information from the input interface 510, send information to the output interface 515, or be integrated in combination with the input interface 510, the output interface 515, or both to receive information, transmit information, or perform various other operations as described herein.

The text chunking component 525 may be configured as or otherwise support a means for processing a text document to generate a set of text chunks, where each text chunk of the set of text chunks may have a length that is based on a total length of the text document. The topic modeling component 530 may be configured as or otherwise support a means for determining one or more topics associated with the set of text chunks, where each topic is associated with respective subsets of text chunks of the set of text chunks based on content similarities within the respective subsets of text chunks. The topic modeling component 530 may be configured as or otherwise support a means for concatenating the respective subsets of text chunks for each topic of the one or more topics. The extractive summarization component 535 may be configured as or otherwise support a means for generating a set of first summaries of the one or more topics by performing a first summarization of content associated with each topic of the one or more topics, where the first summarization is performed by extracting, when a length of the content within the one or more topics satisfies a threshold length, a quantity of sentences from the one or more topics based on the threshold quantity of sentences satisfying a relevance metric. The abstractive summarization component 540 may be configured as or otherwise support a means for generating a set of second summaries by summarizing the set of first summaries using one or more LLMs, where each second summary of the set of second summaries includes a title and a respective summary for each respective first summary of the set of first summaries. The post processing component 545 may be configured as or otherwise support a means for generating a final summary of the text document as a combination of the set of second summaries.

FIG. 6 shows a block diagram 600 of a summarization component 620 that supports techniques for hybrid long-context summarization in accordance with aspects of the present disclosure. The summarization component 620 may be an example of aspects of a summarization component 520, as described herein. The summarization component 620, or various components thereof, may be an example of means for performing various aspects of techniques for hybrid long-context summarization as described herein. For example, the summarization component 620 may include a text chunking component 625, a topic modeling component 630, an extractive summarization component 635, an abstractive summarization component 640, a post processing component 645, a list generation component 650, or any combination thereof. Each of these components, or components of subcomponents thereof (e.g., one or more processors, one or more memories), may communicate, directly or indirectly, with one another (e.g., via one or more buses, communications links, communications interfaces, or any combination thereof).

The text chunking component 625 may be configured as or otherwise support a means for processing a text document to generate a set of text chunks, where the length of the set of text chunks may be based on a total length of the text document. The topic modeling component 630 may be configured as or otherwise support a means for determining one or more topics associated with the set of text chunks, where each topic is associated with respective subsets of text chunks of the set of text chunks based on content similarities within the respective subsets of text chunks. In some examples, the topic modeling component 630 may be configured as or otherwise support a means for concatenating the respective subsets of text chunks for each topic of the one or more topics. The extractive summarization component 635 may be configured as or otherwise support a means for generating a set of first summaries of the one or more topics by performing a first summarization of content associated with each topic of the one or more topics, where the first summarization is performed by extracting, when a length of the content within the one or more topics satisfies a threshold length, a quantity of sentences from the one or more topics based on the threshold quantity of sentences satisfying a relevance metric. The abstractive summarization component 640 may be configured as or otherwise support a means for generating a set of second summaries by summarizing the set of first summaries using one or more LLMs, where each second summary of the set of second summaries includes a title and a respective summary for each respective first summary of the set of first summaries. The post processing component 645 may be configured as or otherwise support a means for generating a final summary of the text document as a combination of the set of second summaries.

In some examples, to support processing the text document to generate the set of text chunks, the text chunking component 625 may be configured as or otherwise support a means for determining the total length of the text document. In some examples, to support processing the text document to generate the set of text chunks, the text chunking component 625 may be configured as or otherwise support a means for separating the text document into the set of text chunks, where each text chunk of the set of text chunks have respective lengths that are based on the total length of the text document.

In some examples, to support processing the text document to generate the set of text chunks, the text chunking component 625 may be configured as or otherwise support a means for recursively splitting the total length of the text document at different locations in the text document marked by one or more identified characters, where the one or more identified characters include a paragraph end, a period, or both.

In some examples, the set of text chunks have respective lengths that are each within a threshold magnitude of each other.

In some examples, the text chunking component 625 may be configured as or otherwise support a means for embedding each text chunk of the set of text chunks in accordance with an embedding model, where the embedding model is based on a multi-dimensional dense vector space.

In some examples, to support determining the one or more topics associated with the set of text chunks, the topic modeling component 630 may be configured as or otherwise support a means for generating a chunk similarity matrix that is indicative of the content similarities between respective pairs of text chunks of the set of text chunks. In some examples, to support determining the one or more topics associated with the set of text chunks, the topic modeling component 630 may be configured as or otherwise support a means for grouping the respective subsets of text chunks using one or more community detection algorithms, wherein each subset of text chunks of the respective subsets of text chunks are similar text chunks identified via the chunk similarity matrix. In some examples, the list generation component 650 may be configured as or otherwise support a means for generating a list based on concatenating the respective subsets of text chunks, where each item of the list is indicative of a respective subset of text chunks assigned to a same topic.

In some examples, the extractive summarization component 635 may be configured as or otherwise support a means for determining that the length of content within the one or more topics includes a set of sentences that fails to satisfy the threshold length. In some examples, the threshold length of the content is configured in accordance with one or more parameters. In some examples, the abstractive summarization component 640 may be configured as or otherwise support a means for generating the set of second summaries using the set of sentences from the one or more topics.

In some examples, the list generation component 650 may be configured as or otherwise support a means for generating a list based on generation of the set of first summaries, where each item of the list is indicative of a respective first summary for a respective topic. In some examples, to support generating the set of second summaries, the abstractive summarization component 640 may be configured as or otherwise support a means for entering, into the one or more LLMs, individual engineered prompts associated with respective individual single first summaries of the set of first summaries. In some examples, to support generating the set of second summaries, the abstractive summarization component 640 may be configured as or otherwise support a means for generating respective individual second summaries of the set of second summaries in accordance with the individual engineered prompts. In some examples, to support generating the set of second summaries, the abstractive summarization component 640 may be configured as or otherwise support a means for generating a corresponding set of titles for each of the respective individual second summaries. In some examples, the combination of the set of second summaries including the final summary includes respective summaries for each topic of the one or more topics. In some examples, the post processing component 645 may be configured as or otherwise support a means for performing a post-processing of the final summary in accordance with a regular expression search. In some examples, the set of first summaries include one or more extractive summaries, and the set of second summaries include one or more abstractive summaries.

FIG. 7 shows a block diagram 700 of a system 705 that supports techniques for hybrid long-context summarization in accordance with aspects of the present disclosure. The system 705 may be an example of or include components of a system 505 as described herein. The system 705 may include components for data management, including components such as a summarization component 720, an input information 710, an output information 715, a network interface 725, at least one memory 730, at least one processor 735, and a storage 740. These components may be in electronic communication or otherwise coupled with each other (e.g., operatively, communicatively, functionally, electronically, electrically; via one or more buses, communications links, communications interfaces, or any combination thereof). Additionally, the components of the system 705 may include corresponding physical components or may be implemented as corresponding virtual components (e.g., components of one or more virtual machines). In some examples, the system 705 may be an example of aspects of one or more components described with reference to FIG. 1, such as a DMS 110.

The network interface 725 may enable the system 705 to exchange information (e.g., input information 710, output information 715, or both) with other systems or devices (not shown). For example, the network interface 725 may enable the system 705 to connect to a network (e.g., a network 120 as described herein). The network interface 725 may include one or more wireless network interfaces, one or more wired network interfaces, or any combination thereof. In some examples, the network interface 725 may be an example of may be an example of aspects of one or more components described with reference to FIG. 1, such as the display 165.

Memory 730 may include RAM, ROM, or both. The memory 730 may store computer-readable, computer-executable software including instructions that, when executed, cause the processor 735 to perform various functions described herein. In some cases, the memory 730 may contain, among other things, a basic input/output system (BIOS), which may control basic hardware or software operation such as the interaction with peripheral components or devices. In some cases, the memory 730 may be an example of aspects of one or more components described with reference to FIG. 1, such as one or more memories 175.

The processor 735 may include an intelligent hardware device, (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 735 may be configured to execute computer-readable instructions stored in a memory 730 to perform various functions (e.g., functions or tasks supporting techniques for hybrid long-context summarization). Though a single processor 735 is depicted in the example of FIG. 7, it is to be understood that the system 705 may include any quantity of one or more of processors 735 and that a group of processors 735 may collectively perform one or more functions ascribed herein to a processor, such as the processor 735. In some cases, the processor 735 may be an example of aspects of one or more components described with reference to FIG. 1. In some aspects, the system 705 may additionally, or alternatively, support various AI-based processes, such as generative AI performed or executed either on-device or off-device (e.g., in the cloud), or both.

Storage 740 may be configured to store data that is generated, processed, stored, or otherwise used by the system 705. In some cases, the storage 740 may include one or more HDDs, one or more SDDs, or both. In some examples, the storage 740 may be an example of a single database, a distributed database, multiple distributed databases, a data store, a data lake, or an emergency backup database. In some examples, the storage 740 may be an example of one or more components described with reference to FIG. 1.

For example, the summarization component 720 may be configured as or otherwise support a means for processing a text document to generate a set of text chunks, where each text chunk of the set of text chunks may have a length that is based on a total length of the text document. The summarization component 720 may be configured as or otherwise support a means for determining one or more topics associated with the set of text chunks, where each topic is associated with respective subsets of text chunks of the set of text chunks based on content similarities within the respective subsets of text chunks. The summarization component 720 may be configured as or otherwise support a means for concatenating the respective subsets of text chunks for each topic of the one or more topics. The summarization component 720 may be configured as or otherwise support a means for generating a set of first summaries of the one or more topics by performing a first summarization of content associated with each topic of the one or more topics, where the first summarization is performed by extracting, when a length of the content within the one or more topics satisfies a threshold length, a quantity of sentences from the one or more topics based on the threshold quantity of sentences satisfying a relevance metric. The summarization component 720 may be configured as or otherwise support a means for generating a set of second summaries by summarizing the set of first summaries using one or more large language models (LLMs), where each second summary of the set of second summaries includes a title and a respective summary for each respective first summary of the set of first summaries. The summarization component 720 may be configured as or otherwise support a means for generating a final summary of the text document as a combination of the set of second summaries.

By including or configuring the summarization component 720 in accordance with examples as described herein, the system 705 may support techniques for techniques for hybrid long-context summarization, which may provide one or more benefits such as, for example, improved reliability and document summarization accuracy, improved user experience, reduced power consumption and reduced reliance on LLM for bulk summarization, more efficient utilization of computing resources, network resources or both, improved scalability, reduced cost, improved LLM model flexibility, reduced positional bias and sensitivity when generating summaries of long-form documents, improved summarization specificity, and improved compression ratio control, among other possibilities.

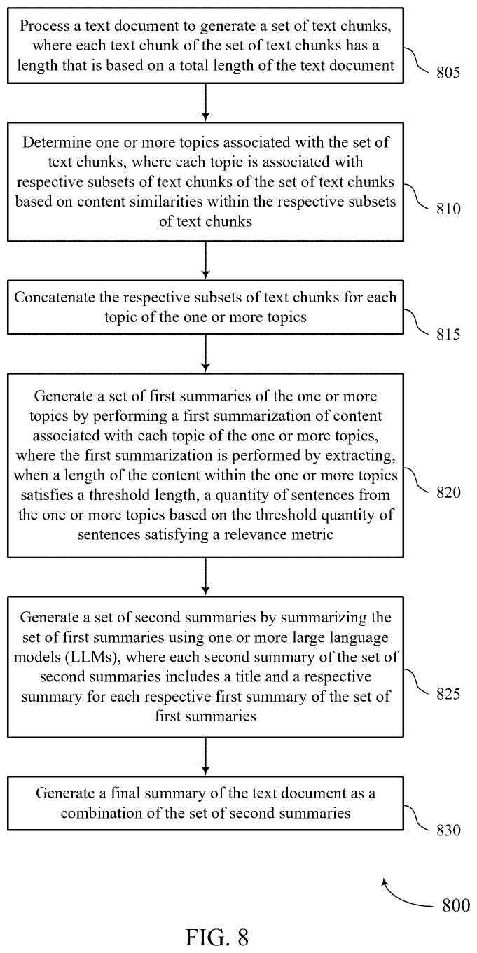

FIG. 8 shows a flowchart illustrating a method 800 that supports techniques for hybrid long-context summarization in accordance with aspects of the present disclosure. The operations of the method 800 may be implemented by a DMS or its components as described herein. For example, the operations of the method 800 may be performed by a DMS as described with reference to FIGS. 1 through 7. In some examples, a DMS may execute a set of instructions to control the functional elements of the DMS to perform the described functions. Additionally, or alternatively, the DMS may perform aspects of the described functions using special-purpose hardware.

At 805, the method may include processing a text document to generate a set of text chunks, where the length of text chunks is based on a total length of the text document. The operations of 805 may be performed in accordance with examples as disclosed herein. In some examples, aspects of the operations of 805 may be performed by a text chunking component 625 as described with reference to FIG. 6.

At 810, the method may include determining one or more topics associated with the set of text chunks, where each topic is associated with respective subsets of text chunks of the set of text chunks based on content similarities within the respective subsets of text chunks. The operations of 810 may be performed in accordance with examples as disclosed herein. In some examples, aspects of the operations of 810 may be performed by a topic modeling component 630 as described with reference to FIG. 6.

At 815, the method may include concatenating the respective subsets of text chunks for each topic of the one or more topics. The operations of 815 may be performed in accordance with examples as disclosed herein. In some examples, aspects of the operations of 815 may be performed by a topic modeling component 630 as described with reference to FIG. 6.

At 820, the method may include generating a set of first summaries of the one or more topics by performing a first summarization of content associated with each topic of the one or more topics, where the first summarization is performed by extracting, when a length of the content within the one or more topics satisfies a threshold length, a quantity of sentences from the one or more topics based on the threshold quantity of sentences satisfying a relevance metric. The operations of 820 may be performed in accordance with examples as disclosed herein. In some examples, aspects of the operations of 820 may be performed by an extractive summarization component 635 as described with reference to FIG. 6.

At 825, the method may include generating a set of second summaries by summarizing the set of first summaries using one or more large language models (LLMs), where each second summary of the set of second summaries includes a title and a respective summary for each respective first summary of the set of first summaries. The operations of 825 may be performed in accordance with examples as disclosed herein. In some examples, aspects of the operations of 825 may be performed by an abstractive summarization component 640 as described with reference to FIG. 6.

At 830, the method may include generating a final summary of the text document as a combination of the set of second summaries. The operations of 830 may be performed in accordance with examples as disclosed herein. In some examples, aspects of the operations of 830 may be performed by a post processing component 645 as described with reference to FIG. 6.

The following provides an overview of aspects of the present disclosure:
Aspect 1: A method, comprising: processing a text document to generate a set of text chunks, wherein each text chunk of the set of text chunks has a length that is based at least in part on a total length of the text document; determining one or more topics associated with the set of text chunks, wherein each topic is associated with respective subsets of text chunks of the set of text chunks based at least in part on content similarities within the respective subsets of text chunks; concatenating the respective subsets of text chunks for each topic of the one or more topics; generating a set of first summaries of the one or more topics by performing a first summarization of content associated with each topic of the one or more topics, wherein the first summarization is performed by extracting, when a length of the content within the one or more topics satisfies a threshold length, a quantity of sentences from the one or more topics based at least in part on the threshold quantity of sentences satisfying a relevance metric; generating a set of second summaries by summarizing the set of first summaries using one or more LLMs, wherein each second summary of the set of second summaries includes a title and a respective summary for each respective first summary of the set of first summaries; and generating a final summary of the text document as a combination of the set of second summaries.
Aspect 2: The method of aspect 1, wherein processing the text document to generate the set of text chunks comprises: determining the total length of the text document; and separating the text document into the set of text chunks, wherein each text chunk of the set of text chunks have respective lengths that are based at least in part on the total length of the text document.
Aspect 3: The method of any of aspects 1 through 2, wherein processing the text document to generate the set of text chunks comprises: recursively splitting the total length of the text document at different locations in the text document marked by one or more identified characters, wherein the one or more identified characters comprise a paragraph end, a period, or both.
Aspect 4: The method of any of aspects 1 through 3, wherein the set of text chunks have respective lengths that are each within a threshold magnitude of each other.
Aspect 5: The method of any of aspects 1 through 4, further comprising: embedding each text chunk of the set of text chunks in accordance with an embedding model, wherein the embedding model is based at least in part on a multi-dimensional dense vector space.
Aspect 6: The method of any of aspects 1 through 5, wherein determining the one or more topics associated with the set of text chunks comprises: generating a chunk similarity matrix that is indicative of the content similarities between respective pairs of text chunks of the set of text chunks.
Aspect 7: The method of any of aspects 1 through 6, wherein determining the one or more topics associated with the set of text chunks comprises: grouping the respective subsets of text chunks using one or more community detection algorithms, wherein each subset of text chunks of the respective subsets of text chunks are similar text chunks identified via the chunk similarity matrix.
Aspect 8: The method of any of aspects 1 through 7, further comprising: generating a list based at least in part on concatenating the respective subsets of text chunks, wherein each item of the list is indicative of a respective subset of text chunks assigned to a same topic.
Aspect 9: The method of any of aspects 1 through 8, further comprising: determining that the length of content within the one or more topics includes a set of sentences that fails to satisfy the threshold length; and generating the set of second summaries using the set of sentences from the one or more topics based at least in part on the length of content failing to satisfy the threshold length.
Aspect 10: The method of any of aspects 1 through 9, wherein the threshold length of the content is configured in accordance with one or more parameters.
Aspect 11: The method of any of aspects 1 through 10, further comprising: generating a list based at least in part on generation of the set of first summaries, wherein each item of the list is indicative of a respective first summary for a respective topic.
Aspect 12: The method of any of aspects 1 through 11, wherein generating the set of second summaries comprises: entering, into the one or more LLMs, individual engineered prompts associated with respective individual single first summaries of the set of first summaries; generating respective individual second summaries of the set of second summaries in accordance with the individual engineered prompts; and generating a corresponding set of titles for each of the respective individual second summaries.
Aspect 13: The method of any of aspects 1 through 12, wherein the combination of the set of second summaries including the final summary comprises respective summaries for each topic of the one or more topics.
Aspect 14: The method of any of aspects 1 through 13, further comprising:
   performing a post-processing of the final summary in accordance with a regular expression search.
Aspect 15: The method of any of aspects 1 through 14, wherein the set of first summaries comprise one or more extractive summaries, and the set of second summaries comprise one or more abstractive summaries.
Aspect 16: An apparatus comprising one or more memories storing processor-executable code, and one or more processors coupled with the one or more memories and individually or collectively operable to execute the code to cause the apparatus to perform a method of any of aspects 1 through 15.
Aspect 17: An apparatus comprising at least one means for performing a method of any of aspects 1 through 15.
Aspect 18: A non-transitory computer-readable medium storing code the code comprising instructions executable by one or more processors to perform a method of any of aspects 1 through 15.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, “a component” having characteristics or performing functions may refer to “at least one of one or more components” having a particular characteristic or performing a particular function. Subsequent reference to a component introduced with the article “a” using the terms “the” or “said” refers to any or all of the one or more components. For example, a component introduced with the article “a” shall be understood to mean “one or more components,” and referring to “the component” subsequently in the claims shall be understood to be equivalent to referring to “at least one of the one or more components.”

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method, comprising:
processing a text document to generate a set of text chunks, wherein each text chunk of the set of text chunks has a length that is based at least in part on a total length of the text document;
determining one or more topics associated with the set of text chunks, wherein each topic is associated with respective subsets of text chunks of the set of text chunks based at least in part on content similarities within the respective subsets of text chunks;
concatenating the respective subsets of text chunks for each topic of the one or more topics;
generating a set of first summaries of the one or more topics by performing a first summarization of content associated with each topic of the one or more topics, wherein the first summarization is performed by extracting, when a length of the content within the one or more topics satisfies a threshold length, a quantity of sentences from the one or more topics based at least in part on the quantity of sentences satisfying a relevance metric;
generating a set of second summaries by summarizing the set of first summaries using one or more large language models (LLMs), wherein each second summary of the set of second summaries includes a title and a respective summary for each respective first summary of the set of first summaries; and
generating a final summary of the text document as a combination of the set of second summaries.

2. The method of claim 1, wherein processing the text document to generate the set of text chunks comprises:
determining the total length of the text document; and
separating the text document into the set of text chunks, wherein each text chunk of the set of text chunks have respective lengths that are based at least in part on the total length of the text document.

3. The method of claim 1, wherein processing the text document to generate the set of text chunks comprises:
recursively splitting the total length of the text document at different locations in the text document marked by one or more identified characters, wherein the one or more identified characters comprise a paragraph end, a period, or both.

4. The method of claim 1, wherein the set of text chunks have respective lengths that are each within a threshold magnitude of each other.

5. The method of claim 1, further comprising:
embedding each text chunk of the set of text chunks in accordance with an embedding model, wherein the embedding model is based at least in part on a multi-dimensional dense vector space.

6. The method of claim 1, wherein determining the one or more topics associated with the set of text chunks comprises:
generating a chunk similarity matrix that is indicative of the content similarities between respective pairs of text chunks of the set of text chunks.

7. The method of claim 6, wherein determining the one or more topics associated with the set of text chunks comprises:
grouping the respective subsets of text chunks using one or more community detection algorithms, wherein each subset of text chunks of the respective subsets of text chunks are similar text chunks identified via the chunk similarity matrix.

8. The method of claim 1, further comprising:
generating a list based at least in part on concatenating the respective subsets of text chunks, wherein each item of the list is indicative of a respective subset of text chunks assigned to a same topic.

9. The method of claim 1, further comprising:
determining that the length of content within the one or more topics includes a set of sentences that fails to satisfy the threshold length; and
generating the set of second summaries using the set of sentences from the one or more topics based at least in part on the length of content failing to satisfy the threshold length.

10. The method of claim 1, wherein the threshold length of the content is configured in accordance with one or more parameters.

11. The method of claim 1, further comprising:
generating a list based at least in part on generation of the set of first summaries, wherein each item of the list is indicative of a respective first summary for a respective topic.

12. The method of claim 1, wherein generating the set of second summaries comprises:
entering, into the one or more LLMs, individual engineered prompts associated with respective individual single first summaries of the set of first summaries;
generating respective individual second summaries of the set of second summaries in accordance with the individual engineered prompts; and
generating a corresponding set of titles for each of the respective individual second summaries.

13. The method of claim 1, wherein the combination of the set of second summaries including the final summary comprises respective summaries for each topic of the one or more topics.

14. The method of claim 1, further comprising:
performing a post-processing of the final summary in accordance with a regular expression search.

15. The method of claim 1, wherein the set of first summaries comprise one or more extractive summaries, and the set of second summaries comprise one or more abstractive summaries.

16. An apparatus, comprising:
one or more memories storing processor-executable code; and
one or more processors coupled with the one or more memories and individually or collectively operable to execute the code to cause the apparatus to:
process a text document to generate a set of text chunks, wherein each text chunk of the set of text chunks has a length that is based at least in part on a total length of the text document;
determine one or more topics associated with the set of text chunks, wherein each topic is associated with respective subsets of text chunks of the set of text chunks based at least in part on content similarities within the respective subsets of text chunks;
concatenate the respective subsets of text chunks for each topic of the one or more topics;
generate a set of first summaries of the one or more topics by performing a first summarization of content associated with each topic of the one or more topics, wherein the first summarization is performed by extracting, when a length of the content within the one or more topics satisfies a threshold length, a quantity of sentences from the one or more topics based at least in part on the quantity of sentences satisfying a relevance metric;
generate a set of second summaries by summarizing the set of first summaries using one or more large language models (LLMs), wherein each second summary of the set of second summaries includes a title and a respective summary for each respective first summary of the set of first summaries; and
generate a final summary of the text document as a combination of the set of second summaries.

17. The apparatus of claim 16, wherein, to process the text document to generate the set of text chunks, the one or more processors are individually or collectively operable to execute the code to cause the apparatus to:
determine the total length of the text document; and
separate the text document into the set of text chunks, wherein each text chunk of the set of text chunks have respective lengths that are based at least in part on the total length of the text document.

18. The apparatus of claim 16, wherein, to process the text document to generate the set of text chunks, the one or more processors are individually or collectively operable to execute the code to cause the apparatus to:
recursively split the total length of the text document at different locations in the text document marked by one or more identified characters, wherein the one or more identified characters comprise a paragraph end, a period, or both.

19. The apparatus of claim 16, wherein the set of text chunks have respective lengths that are each within a threshold magnitude of each other.

20. A non-transitory computer-readable medium storing code, the code comprising instructions executable by one or more processors to:
process a text document to generate a set of text chunks, wherein each text chunk of the set of text chunks has a length that is based at least in part on a total length of the text document;
determine one or more topics associated with the set of text chunks, wherein each topic is associated with respective subsets of text chunks of the set of text chunks based at least in part on content similarities within the respective subsets of text chunks;
concatenate the respective subsets of text chunks for each topic of the one or more topics;
generate a set of first summaries of the one or more topics by performing a first summarization of content associated with each topic of the one or more topics, wherein the first summarization is performed by extracting, when a length of the content within the one or more topics satisfies a threshold length, a quantity of sentences from the one or more topics based at least in part on the quantity of sentences satisfying a relevance metric;
generate a set of second summaries by summarizing the set of first summaries using one or more large language models (LLMs), wherein each second summary of the set of second summaries includes a title and a respective summary for each respective first summary of the set of first summaries; and
generate a final summary of the text document as a combination of the set of second summaries.
